(19) United States
(12) Patent Application Publication
(10) Pub. No.: US 2024/0127833 A1
(43) Pub. Date: Apr. 18, 2024

(54) SYSTEM AND METHODS THEREOF FOR AUDIO AUTHENTICATION

(71) Applicant: InSoundz Ltd., Tel Aviv (IL)

(72) Inventors: Tomer GOSHEN, Hod Ha-Sharon (IL); Emil WINEBRAND, Petah Tikva (IL); Guy ETGAR, Tel Aviv (IL)

(73) Assignee: InSoundz Ltd., Tel Aviv (IL)

(21) Appl. No.: 18/396,417

(22) Filed: Dec. 26, 2023

Related U.S. Application Data
(63) Continuation of application No. PCT/IB2022/055954, filed on Jun. 27, 2022.
(60) Provisional application No. 63/215,809, filed on Jun. 28, 2021.

(51) Int. Cl. G10L 19/018; G06F 21/64; G10L 21/0272

(52) U.S. Cl. CPC G10L 19/018; G06F 21/64; G10L 21/0272

(57) ABSTRACT

A system and method for authenticating audio. A method includes sampling audio captured by an array of microphones based on sound produced by audio sources; generating an audio channel per audio source for the audio captured by the array of microphones, wherein each audio channel is a portion of the sampled audio produced by a respective audio source; generating a unique acoustic signature (UAS) for the audio sources by processing portions of the sampled audio of each audio source in order to create processed audio, wherein the UAS is a set of acoustical parameters representing acoustical properties of each audio source; generating a hashing value based on the UAS and the audio channel per audio source; and encoding the processed audio using the hashing value in order to generate encoded audio, wherein the encoded audio is authenticated using the hashing value and the UAS.

### CROSS-REFERENCE TO RELATED APPLICATIONS

This application is a continuation of International Application No. PCT/162022/055954, filed on Jun. 27, 2022, now pending, claims the benefit of U.S. Provisional Application No. 63/215,809 filed on Jun. 28, 2021, the contents of which are hereby incorporated by reference.

### TECHNICAL FIELD

The present disclosure relates generally to authentication, and more specifically to authenticating audio clips or streams.

### BACKGROUND

Use of audio streams and audio clips with or without accompanying video has become ubiquitous. Audio can be provided these days in many forms, but this comes at a price. In recent years, various attempts have been made to manipulate voices in order to generate audio content that is seemingly based on an authentic speaker's voice where in fact that audio was manipulated. This has been demonstrated, unfortunately, many times in the political arena when an interested party uses an original audio that is distorted to make it seems as if it is the original audio.

Existing solutions include ways to provide various types of watermarks to protect the audio content so that it can be authenticated. However, as the ability to distort audio increases, it is becoming increasingly necessary to overcome the limited capabilities of protection in order to provide better protection against audio forgeries. Therefore, it would be advantageous to provide an efficient solution for effective and efficient audio watermarking and/or fingerprinting that is difficult to bypass.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for authenticating audio. The method comprises: sampling audio captured by an array of microphones, wherein the audio captured by the array of microphones is captured based on sound produced by at least one audio source; generating an audio channel per audio source for the audio captured by the array of microphones, wherein each audio channel is a portion of the sampled audio produced by a respective audio source of the at least one audio source; generating a unique acoustic signature (UAS) for the at least one audio source by processing at least portions of the sampled audio of each audio source in order to create processed audio, wherein the UAS is a set of acoustical parameters representing acoustical properties of each of the at least one audio source; generating a hashing value based on the UAS and the audio channel per audio source; and encoding the processed audio using the hashing value in order to generate encoded audio, wherein the encoded audio is authenticated using the hashing value and the UAS.

Certain embodiments disclosed herein also include a non-transitory computer readable medium having stored thereon causing a processing circuitry to execute a process, the process comprising: sampling audio captured by an array of microphones, wherein the audio captured by the array of microphones is captured based on sound produced by at least one audio source; generating an audio channel per audio source for the audio captured by the array of microphones, wherein each audio channel is a portion of the sampled audio produced by a respective audio source of the at least one audio source; generating a unique acoustic signature (UAS) for the at least one audio source by processing at least portions of the sampled audio of each audio source in order to create processed audio, wherein the UAS is a set of acoustical parameters representing acoustical properties of each of the at least one audio source; generating a hashing value based on the UAS and the audio channel per audio source; and encoding the processed audio using the hashing value in order to generate encoded audio, wherein the encoded audio is authenticated using the hashing value and the UAS.

Certain embodiments disclosed herein also include a system for authenticating audio. The system comprises: a processing circuitry; and a memory, the memory containing instructions that, when executed by the processing circuitry, configure the system to: sample audio captured by an array of microphones, wherein the audio captured by the array of microphones is captured based on sound produced by at least one audio source; generate an audio channel per audio source for the audio captured by the array of microphones, wherein each audio channel is a portion of the sampled audio produced by a respective audio source of the at least one audio source; generate a unique acoustic signature (UAS) for the at least one audio source by processing at least portions of the sampled audio of each audio source in order to create processed audio, wherein the UAS is a set of acoustical parameters representing acoustical properties of each of the at least one audio source; generate a hashing value based on the UAS and the audio channel per audio source; and encode the processed audio using the hashing value in order to generate encoded audio, wherein the encoded audio is authenticated using the hashing value and the UAS.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an illustration showing capturing of audio by a microphone array unit according to an embodiment.

FIG. 2 is a schematic diagram of a microphone array unit according to an embodiment.

FIG. 3 is a block diagram illustrating the flow of capturing, labeling, hashing and authenticating audio content according to an embodiment.

FIG. 4 is a flow diagram illustrating watermark embedding according to an embodiment.

FIG. 5 is a flow diagram illustrating watermark decoding according to an embodiment.

FIG. 6 is a network diagram utilized to describe various disclosed embodiments.

FIG. 7 is an illustration of per-speaker directivity patterns according to an embodiment.

FIG. 8 is a flowchart illustrating a method for authenticating audio according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Audio provided as an audio clip or an audio stream is prone to abuse and therefore, periodically a watermark, or fingerprint, is generated. A plurality of microphones of a microphone array detects a unique fingerprint print for each of at least one audio source. This is done by characterizing one or more parameters relating to the audio channel between the at least one audio source and the microphone array, to create a unique acoustic signature (UAS), by determining the directivity pattern of the at least an audio source, as well as the processed to raw audio correlation. The UAS may be generated as, for example, a plurality of frequency bins per microphone. An authentication agent generates a hashing of the UAS and the processed audio that are provided to a watermarking encoder. The hashing is provided to an authentication server so that a user device may authenticate received audio against its respective hash.

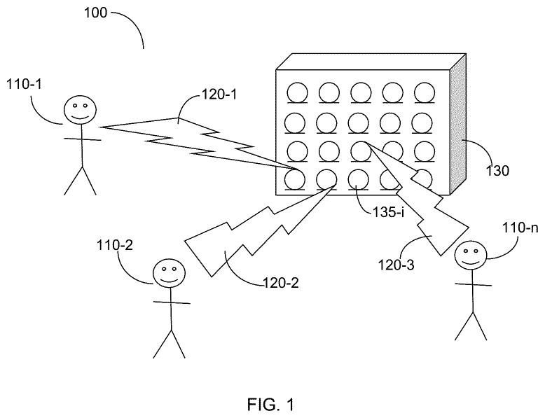

FIG. 1 is an illustration 100 showing capturing of audio by a microphone array unit 130 according to an embodiment. FIG. 1 depicts a plurality of audio sources 110-1 through 110-n (where ‘n’ is an integer equal to or greater than ‘1’), hereinafter referred to individually as an audio source 110 or collectively as audio sources 110. In the non-limiting illustration 100, the audio sources 110 are speakers. It should be understood that, although speakers are referred to herein, it is not required that an audio source 110 be a person, and that other sources of audio, for example, a musical instrument or an animal, may be an audio source 110 without departing from the scope of the disclosure. In other words, each audio source 110 is a source of audio that speaks, projects, or otherwise produces sound that can be captured (e.g., via microphones 135) as audio.

Each audio source 110 may be located in a different location and may further have different vocal or other sound-producing characteristics. When one of the audio sources 110 (e.g., the audio source 110-1) is generating an audio, for example when speaking or singing, an audio channel 120 (e.g., the audio channel 120-1) is created between the audio source 110 and a microphone array unit (MAU) 130.

The MAU 130 is configured to process the audio received for each audio channel 120 via one or more of a plurality of microphones such as a microphone 135-i and generates a fingerprinted or watermarked audio such as an audio clip or audio stream. The fingerprint is generated based on the characteristics of the audio channel 120 between the MAU 130 and an audio source 110, for example per frequency bin per microphone. The fingerprint may further be generated based on a directivity pattern, i.e., the position of the audio source 120 with respect of the MAU 130. For example, the directivity pattern is different when a speaker 110 speaks towards the MAU 130 as compared to when the speaker 110 speaks away from the MAU 130. Furthermore, the fingerprint may be generated based further on the processed audio to raw audio correlation. A hashing value can then be generated as follows:

F=hashing(CH,DP,PC) Equation 1

In Equation 1, F is the fingerprint to be used as a hashing value, CH is the characteristics of the audio channel, DP is the directivity pattern, and PC is the processed audio to raw audio correlation.

A non-limiting example of hashing argument representation according to an embodiment may therefore be described as follows. The sound source acoustical channel matrix may be represented as:

h[m,n] or H[m,k] Expressions 1

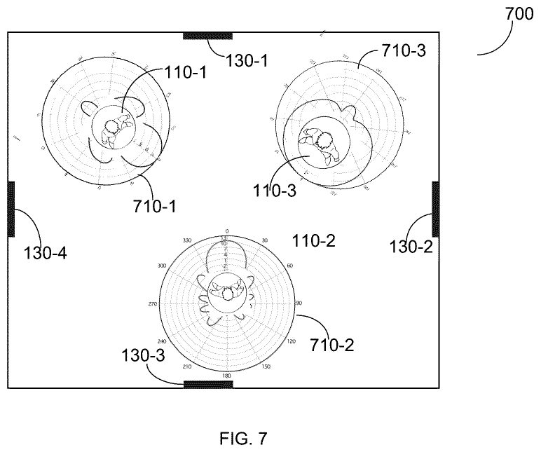

In the Expressions 1, the time domain of an impulse response of microphone ‘m’ is sample ‘n’, or is the frequency bin ‘k’ in the frequency domain of microphone ‘m’. A sound source directivity pattern, further discussed herein with respect to FIG. 7, may have a matrix representation as follows:

D[arg,k] or D[base,k] Expressions 2

In the Expressions 2, D is the directivity pattern, ‘arg’ is the angle with regards to common axis for frequency bin ‘k’, and ‘base’ is the projection value of the sound source with regards to spatial base (spherical/cylindrical harmonic).

Reference is now made to FIG. 7, which depicts an example illustration 700 of a directivity pattern per speaker for the speakers serving as the audio sources 110 shown in FIG. 1. As depicted in FIG. 7, the three speakers 110-1, 110-2, and 110-3 are positioned within an area. On the walls of that area, there are positioned a plurality of MAUs 130-1 through 130-4, each of the MAUs 130-1 through 130-4 is configured to perform at least a portion of the disclosed embodiments as described herein with respect to the MAU 130. Each speaker 110 has a respective unique directivity pattern depicted as directivity patterns 710-1, 710-2, and 710-3, respectively. The raw audio to processed audio correlation matrix may be represented as:

Corr[m]=E{P[k]*Raw[m,k]} Equation 2

In Equation 2, ‘m’ is the microphone index, Raw is the raw audio signal, P is the processed audio, and E is the mean of probability distribution function.

It should therefore be appreciated that the UAS is a set of acoustical parameters that represent the acoustical properties of each sound source (e.g., each of the speaker audio sources 110, FIG. 1) in a given space. These example arguments used for the hashing are the UAS, and are taken into account when generating the hashing such that the resulting hashing value may be used for the detection, according to embodiments described in greater detail herein, of attempts to manipulate the processed audio in impermissible ways, for example, beyond a predetermined threshold value. It should be noted that the hashing is performed periodically, for example but not by way of limitation, every predetermined number of seconds, so that a plurality of hashing values accompanies the audio (e.g., the audio clip or stream). In an embodiment, the hashing function is a non-reversible function which provides a unique value per argument.

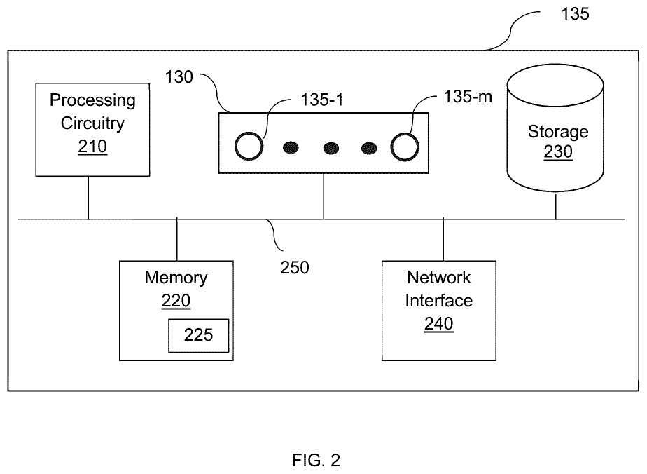

FIG. 2 is an example schematic diagram of a microphone array unit 130 according to an embodiment. The microphone array unit 130 includes a processing circuitry 210 coupled to a memory 220, a microphone array 130 including a plurality of microphones 135-1 through 135-m (referred to individually as a microphone 135 or collectively as microphones 135), a storage 230, and a network interface 240. In an embodiment, the components of the microphone array unit 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 220 may be volatile (e.g., random access memory, etc.), non-volatile (e.g., read only memory, flash memory, etc.), or a combination thereof. In some embodiments, the memory 220 includes a code section 225 including code for performing at least a portion of the disclosed techniques.

The microphones 135 of the microphone array 130 are configured to capture audio projected or otherwise caused by one or more audio sources such as, but not limited to, speakers, musical instruments, animals, or any other sources of sound. Audio captured by the microphones 135 may be encoded as described herein.

In one configuration, software for implementing one or more embodiments disclosed herein may be stored in the storage 230. In another configuration, the memory 220 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein.

The storage 230 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

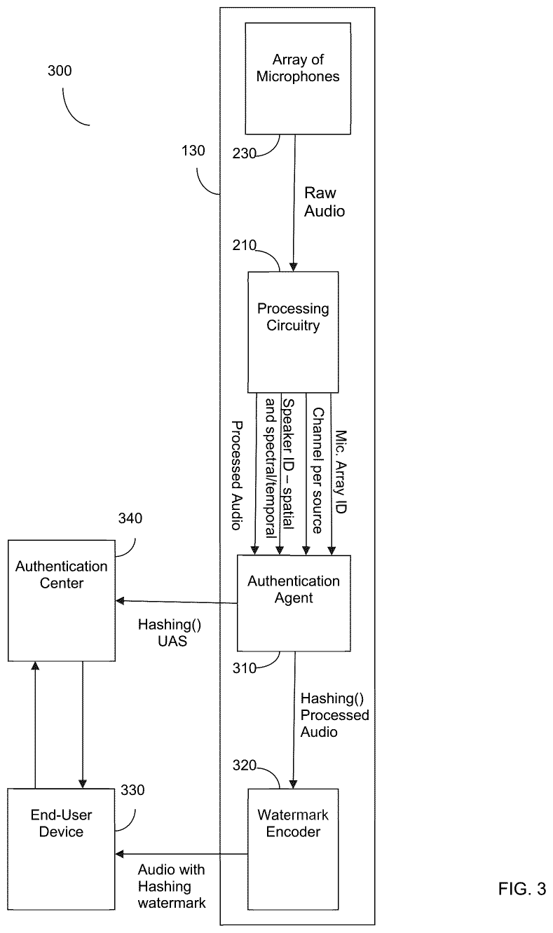

The network interface 240 allows the microphone array unit 130 to communicate with, for example, one or more user devices (e.g., the user device 330, FIG. 3), an authentication center (e.g., the authentication center 340, FIG. 3), both, and the like.

It should be understood that the embodiments described herein are not limited to the specific architecture illustrated in FIG. 2, and other architectures may be equally used without departing from the scope of the disclosed embodiments.

FIG. 3 is a block diagram 300 illustrating the flow of capturing, labeling, hashing and authenticating audio content according to an embodiment.

As shown in FIG. 3, the MAU 130 captures, via an array of microphones (AoM) 230, raw audio that is provided to the processing circuitry 210. By execution of the code stored in code section 225 of memory 220 (not shown in FIG. 3), the processing circuitry 210 provides an authentication agent (AA) 310 data about the captured audio which includes a unique identifier of the AoM 230, channel information per audio source 110, audio source identification that is based on at least one of spectral or temporal characteristics as well as spatial characteristics, and the processed audio.

The AA 310, executing, for example, on the processing circuitry 210 based on code stored in code section 225 of memory 220, provides a hashing respective of the provided data as well as the processed audio to a watermark encoder 320.

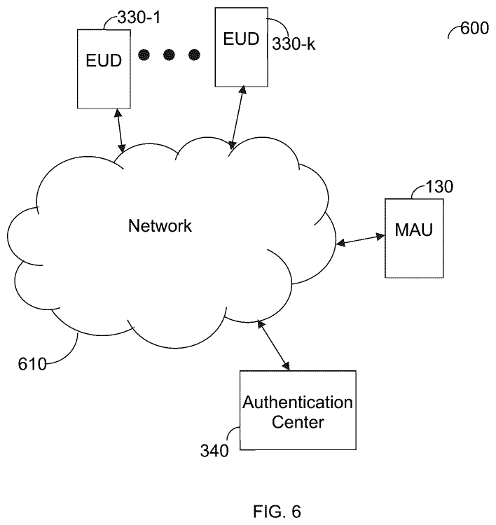

The watermark encoder 320 may execute a process via the processing circuitry 210 by execution of code stored in code section 225 of memory 220. The output of the watermark encoder 320 is the audio (clip or stream) accompanied by a hashing watermark. This output is provided, for example, to an end-user device 330 that consumes the audio (clip or stream). The AA 310 provides the hashing for the processed audio and the UAS to an authentication center (AC) 340, which may be a server communicatively connected to the MAU 130, and as further explained with respect of FIG. 6 herein.

According to an embodiment, when the end-user device 330 wishes to authenticate an audio, an audio authentication request is sent to the AC 340 which, after checking, provides an audio authentication response. The process includes the following steps performed by the AC 340: a) receiving an audio authentication request that includes the watermark information; b) decoding the watermark received; c) estimating an error from the original watermark (the hashing originally received from the AA 310 for the particular audio [clip or stream] or portion thereof [it should be understood that each audio clip or audio stream may be partitioned to segments each having its own hashing]); d) retrieving metadata and information necessary to be sent back as part of the authentication process; and e) sending audio authentication response (audio report) to the requesting end-user device 330.

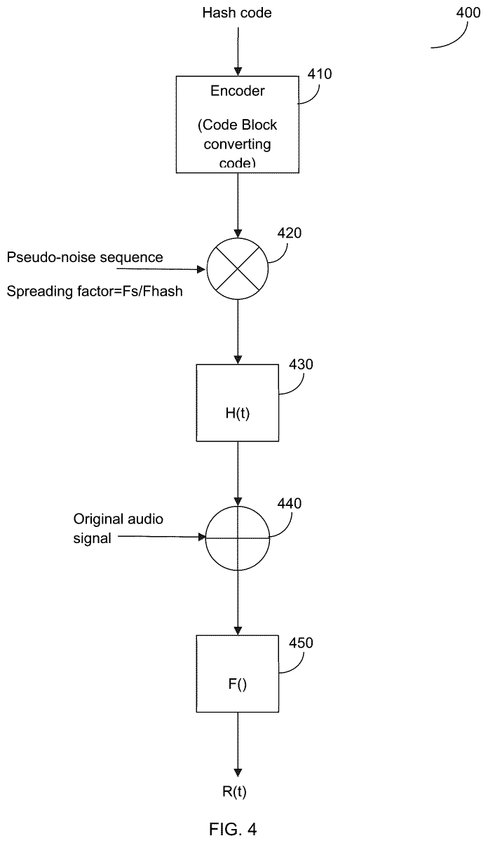

FIG. 4 is a flow diagram 400 illustrating watermark embedding according to an embodiment. In an embodiment, the flow depicted in FIG. 4 is performed by the watermark encoder 320, FIG. 3.

As depicted in FIG. 4, a hash code is received by an encoder 410 that is configured to provide the encoded information, for example by using a code block conversion code, to a multiplier unit 420. The multiplier unit 420 multiplies that result with a pseudo-noise sequence, e.g., m-sequence, with a spreading factor of Fs/Fhash. A conversion block H(t) 430 converts the output of the multiplier and provides the multiplier output to a summation unit 440 that adds to the original processed audio signal to the multiplier output. A signal manipulation block 450 provides for allowed manipulation of the signal which includes certain valid manipulations such as EQ, NR, compression, vocode and resampling. The signal manipulation block 450 may further exclude certain manipulations such as, but not limited to, cut fragments or inserts, which may be considered to be illegal manipulation of the audio signal. Hence, in an embodiment, modulated hashing data with spread spectrum watermark uses Pseudo-noise (PN) sequence, and furthermore, modulation of the hashing data takes place over the ultrasonic domain at greater than 20 KHz.

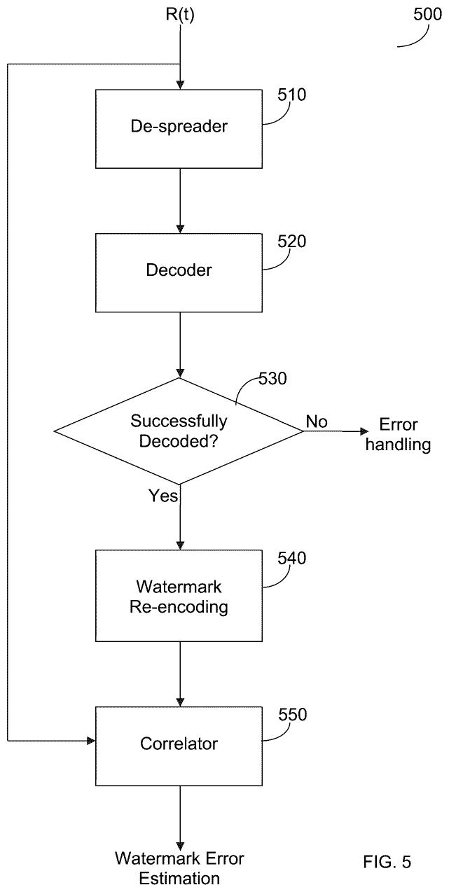

FIG. 5 is a flow diagram 500 illustrating watermark decoding according to an embodiment.

As depicted in FIG. 5, a signal R(t) is received by a de-spreader 510 and is decoded 520. It is checked 530 whether the decoding was successful and, if so, execution continues with 540; otherwise an error signal is sent which may result in another attempt to decode the content, a request to resend the content, and the like. At 540, the watermark is re-encoded and then the re-encoded signal is correlated with the R(t) by a correlator 550. The result of the correlator 550 is an error estimation. If the error estimation is within a predetermined threshold, then the audio (clip or stream) is considered authentic; otherwise, an error message is sent.

FIG. 6 shows an example network diagram 600 utilized to describe various disclosed embodiments. In the example network diagram 600, the MAU 130 communicates via a network 610. The network 610 may be, but is not limited to, a wireless, cellular or wired network, a local area network (LAN), a wide area network (WAN), a metro area network (MAN), the Internet, the worldwide web (WWW), similar networks, and any combination thereof.

To the network 610 there are communicatively connected the authentication center (AC) 340 and one or more end-user devices (EUDs) 330, for example end user devices 330-1 through 330-k (where ‘k’ is an integer equal to or greater than ‘1’). When operative, the MAU 130 captures audio as explained herein. The MAU 130 provides the audio with a hashing to a user device such as one of the end-user devices 330 and provides the hashing to the AC 340. When one of the end-user devices 330 wishes to authenticate the audio (e.g., an audio clip or stream, or portion thereof) a request for authentication is sent over the network 610 to the AC 340. If authentication by the AC 340 is affirmative, a confirmation of such authenticity is sent; otherwise, the authentication is declined. Each end-user device 330 may be, but is not limited to, a personal computer, a laptop, a tablet computer, a smartphone, a wearable computing device, or any other device capable of sending requests, receiving authentications, and projecting authenticated audio content.

Therefore, in an embodiment, a MAU 130 for generation of audio authentication could comprise: a processing circuitry (e.g., the processing circuitry 210); an array of microphones (e.g., the array 230) communicatively connected to the processing unit, the array of microphones comprising a plurality of microphones, wherein the microphone array comprising a unique microphone array identification; a network interface communicatively connected to the processing unit and further comprising an interface to a communication network, for example, network interface 240; a memory communicatively connected to the processing unit, for example memory 220 at least a portion of the memory containing therein instructions, for example code memory 225, that when executed by the processing unit perform: sampling raw audio from the NAU 130; extracting the unique identification of the MAU 130; generating an audio channel per audio source captured by the MAU 130; generating a unique source identifier to each audio source; generating a UAS by processing at least portions of the sampled raw audio of each audio source; generating by an authentication agent 310 a hashing value based on the UAS and the processed audio; transferring the hashing value and processed audio to a watermark encoder 320 for encoding; transmitting the encoded audio using the network interface 240 to at least a designated destination 330; and, transmitting the hashing value and the UAS to an authentication server 340 to enable audio authentication by the designated destination. In another embodiment of MAU 130 the UAS comprises at least one of: channel parameters of each audio source, directivity pattern of each audio source, and processed audio to raw audio correlation. In yet another embodiment, generation of the UAS occurs at predetermined periods of time. Furthermore, in an embodiment the hashing of the UAS is non-reversible.

One of ordinary skill in the art would readily appreciate that audio tracking changes the metadata. In an embodiment, each audio segment may be tagged and post processed, e.g., by a filter, compression, or noise reduction. In addition or alternatively, a timestamp may be added. In an embodiment, without audio tracking that changes metadata of the original audio (clip or stream, or portion thereof as the case may be), the audio may be watermarked on the microphone level, e.g., in data stored by the MAU 130. Every audio manipulation being applied to the watermark therefore allows for estimating the error from the original watermark waveform. If the error power is higher than a predetermined threshold, the audio will be declared as being not authentic or otherwise declined as non-authentic.

In another embodiment, with audio tracking that changes metadata, the tracking changes metadata is created and attached to the original audio (clip or stream, or portion thereof as the case may be) together with hashing of the original audio. In a further embodiment, every process of the audio automatically updates the metadata.

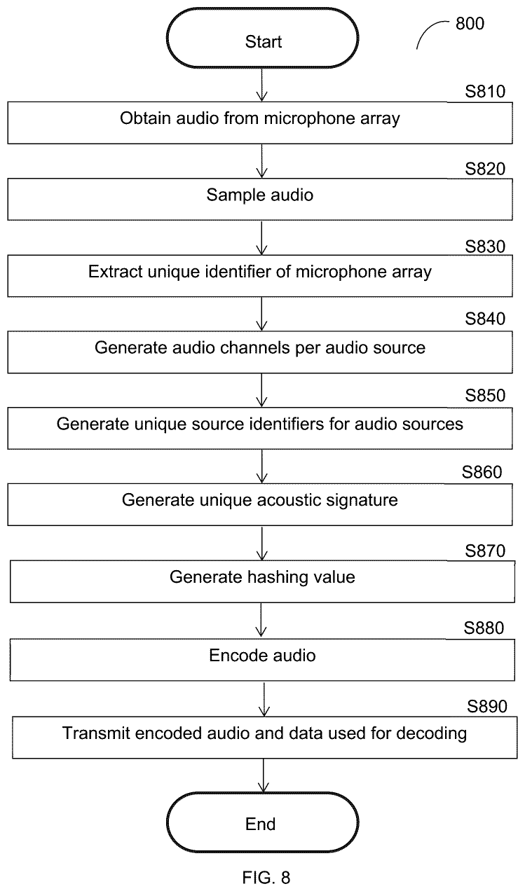

FIG. 8 is a flowchart 800 illustrating a method for authenticating audio according to an embodiment. In an embodiment the method may be performed by the microphone array unit 130.

At S810, audio is obtained from a microphone array. The audio is captured by the microphone array based on sound produced by one or more audio sources. The audio sources may be, but are not limited to, human speakers, animals, musical instruments, or other living beings or objects which produce sound which can be perceived by the microphone array.

At S820, the audio is sampled.

At S830, a unique identifier of the microphone array is extracted. The unique identifier may be extracted, for example, from data stored in a microphone array unit (e.g., the MAU 130) including the microphone array.

At S840, an audio channel is generated for each audio source based on the sampled audio. The audio channels in the sampled audio may be generated based on audio channels formed between the audio sources and the microphone array that captured the raw audio.

At S850, a unique source identifier is generated for each audio source. The source identifiers are at least unique with respect to each other, i.e., such that the same source identifier is not shared between different audio sources.

At S860, a unique acoustic signature (UAS) is generated. The UAS is a set of acoustical parameters representing acoustical properties of each of the audio sources, and acts as a unique fingerprint detected for the respective audio source. In an embodiment, S860 includes determining the directivity pattern of the at least an audio source, as well as the processed to raw audio correlation. To this end, S860 may further include processing at least portions of the sampled audio of each audio source in order to create processed audio. The UAS may be generated as, for example, a plurality of frequency bins per microphone.

At S870, a hashing value is generated using the UAS and the audio channels. In an embodiment, the hashing value may be generated using Equation 1 discussed above. In a further embodiment, the hashing value may be generated based further on the unique identifier of the microphone array, the unique source identifier for each audio source, or both.

At S880, the processed audio is encoded using the hashing value in order to create encoded audio. In doing so, the encoded audio is created such that the UAS and the hashing value can be utilized to verify the authenticity of the processed audio.

At S890, the encoded audio and data used for decoding the encoded audio are transmitted to respective destinations. The data used for decoding the encoded audio may include, but is not limited to, the unique acoustic signature and the hashing value. The encoded audio is sent to a device of an intended recipient, and the data used for decoding the encoded audio is sent to an authentication server that is configured to authenticate audio using such data.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for authenticating audio, comprising:
sampling audio captured by an array of microphones, wherein the audio captured by the array of microphones is captured based on sound produced by at least one audio source;
generating an audio channel per audio source for the audio captured by the array of microphones, wherein each audio channel is a portion of the sampled audio produced by a respective audio source of the at least one audio source;
generating a unique acoustic signature (UAS) for the at least one audio source by processing at least portions of the sampled audio of each audio source in order to create processed audio, wherein the UAS is a set of acoustical parameters representing acoustical properties of each of the at least one audio source;
generating a hashing value based on the UAS and the audio channel per audio source; and
encoding the processed audio using the hashing value in order to generate encoded audio, wherein the encoded audio is authenticated using the hashing value and the UAS.

2. The method of claim 1, further comprising:
transmitting the hashing value and the UAS to an authentication server, wherein the authentication server is configured to authenticate audio received from a device using the hashing value and the UAS.

3. The method of claim 2, further comprising:
transmitting the encoded audio to the device.

4. The method of claim 1, further comprising:
extracting a unique identifier of the array of microphones, wherein the hashing value is generated based further on the unique identifier of the array of microphones.

5. The method of claim 1, further comprising:
generating a unique source identifier for each of the at least one audio source, wherein the hashing value is generated based further on the unique source identifier for each of the at least one audio source.

6. The method of claim 1, wherein the hashing of the UAS is non-reversible.

7. The method of claim 1, wherein the UAS is any of: an audio clip, a portion of an audio clip, an audio stream, and a portion of an audio stream.

8. The method of claim 1, wherein the UAS is generated periodically.

9. The method of claim 1, wherein the UAS includes at least one of: channel parameters of each audio source, directivity pattern of each audio source, and processed audio to raw audio correlation.

10. A non-transitory computer readable medium having stored thereon instructions for causing a processing circuitry to execute a process, the process comprising:
sampling audio captured by an array of microphones, wherein the audio captured by the array of microphones is captured based on sound produced by at least one audio source;
generating an audio channel per audio source for the audio captured by the array of microphones, wherein each audio channel is a portion of the sampled audio produced by a respective audio source of the at least one audio source;
generating a unique acoustic signature (UAS) for the at least one audio source by processing at least portions of the sampled audio of each audio source in order to create processed audio, wherein the UAS is a set of acoustical parameters representing acoustical properties of each of the at least one audio source;
generating a hashing value based on the UAS and the audio channel per audio source; and
encoding the processed audio using the hashing value in order to generate encoded audio, wherein the encoded audio is authenticated using the hashing value and the UAS.

11. A system for authenticating audio, comprising:
a processing circuitry; and
a memory, the memory containing instructions that, when executed by the processing circuitry, configure the system to:
sample audio captured by an array of microphones, wherein the audio captured by the array of microphones is captured based on sound produced by at least one audio source;
generate an audio channel per audio source for the audio captured by the array of microphones, wherein each audio channel is a portion of the sampled audio produced by a respective audio source of the at least one audio source;
generate a unique acoustic signature (UAS) for the at least one audio source by processing at least portions of the sampled audio of each audio source in order to create processed audio, wherein the UAS is a set of acoustical parameters representing acoustical properties of each of the at least one audio source;
generate a hashing value based on the UAS and the audio channel per audio source; and
encode the processed audio using the hashing value in order to generate encoded audio, wherein the encoded audio is authenticated using the hashing value and the UAS.

12. The system of claim 11, wherein the system is further configured to:
transmit the hashing value and the UAS to an authentication server, wherein the authentication server is configured to authenticate audio received from a device using the hashing value and the UAS.

13. The system of claim 12, wherein the system is further configured to:
transmit the encoded audio to the device.

14. The system of claim 11, wherein the system is further configured to:
extract a unique identifier of the array of microphones, wherein the hashing value is generated based further on the unique identifier of the array of microphones.

15. The system of claim 11, wherein the system is further configured to:
generate a unique source identifier for each of the at least one audio source, wherein the hashing value is generated based further on the unique source identifier for each of the at least one audio source.

16. The system of claim 11, wherein the hashing of the UAS is non-reversible.

17. The system of claim 11, wherein the UAS is any of: an audio clip, a portion of an audio clip, an audio stream, and a portion of an audio stream.

18. The system of claim 11, wherein the UAS is generated periodically.

19. The system of claim 11, wherein the UAS includes at least one of: channel parameters of each audio source, directivity pattern of each audio source, and processed audio to raw audio correlation.
